(19) United States
(12) Patent Application Publication
(10) Pub. No.: US 2003/0002086 A1
(43) Pub. Date: Jan. 2, 2003

(54) System and method for capture and utilization of content and source information

(76) Inventor: Tamra L. Thomason, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/896,878

(22) Filed: Jun. 29, 2001

(51) Int. Cl. H04N 1/40

(52) U.S. Cl. 358/448

(57) ABSTRACT

The present disclosure provides a system and method for capture and utilization of content source information. According to one aspect of the invention, the method comprises the steps of electronically capturing content, electronically capturing source information pertinent to the source of the captured content, associating the content and the source information; and transmitting the content and source information to a device for manipulation. According to another aspect of the invention, the method comprises the steps of receiving content and associated source information pertinent to the source of the content in electronic form, reconfiguring the content and associated source information for use in a user application, and automatically creating at least one source acknowledgement in the user application.

### FIELD OF THE INVENTION

The present disclosure relates to a system and method for capture and utilization of content and source information. More particularly, the disclosure relates to a system and method with which content contained within a hardcopy source, such as a book or magazine, can be captured and integrated with a user application, such as a word processing application, along with information about the source of the captured content.

### BACKGROUND OF THE INVENTION

Researchers often collect information (i.e., content) from various different sources when conducting research on a particular topic. Once this information is collected, the researcher often then creates a document describing his or her findings. For instance, students often consult various library books when conducting research for assignments in which the student is required to write a paper on a particular topic.

Where the researcher relies upon information located in one or more sources in creating the research document, the researcher normally provides acknowledgements of the sources for the located information reflected in the document. For example, where general concepts found in a particular source are reflected in the document, the researcher may provide a bibliography identifying the source as providing the basis for the document. Where a quote is provided from the source or a particular piece of information (e.g., a fact or idea) expressed in the source is reproduced, the researcher may further provide a footnote or endnote that identifies the origin of the quote or other piece of information.

When the research is conducted, the researcher typically records information located during the research on which the researcher may later rely in creating a document. For instance, the researcher may take handwritten notes of the content expressed in the source or may photocopy one or more pages of the source for future reference. In the former case, recordation of the information can be tedious, particularly where large amounts of content are being taken from the source. In the latter case, the researcher must normally tab the various passages of the sources, carry them to a copy machine, make the photocopies (typically in exchange for a fee), and then return the sources.

In addition to recording the content found in the sources, the researcher must normally further record bibliographic information concerning the sources so that, if this content is later used in creating the document, proper acknowledgement of the sources can be provided. Recordation of this information can also be tedious for the researcher whether the researcher is taking handwritten notes or using a photocopier. In the former case, the researcher must write down the bibliographic information of the source, including an identification of particular pages where particular quotes or other specific pieces of information were found. In recording this information, the researcher must be careful to collect all relevant bibliography information so that proper acknowledgement can later be provided. In the photocopying context, the researcher must photocopy the bibliographic information (e.g., contained on the title page of the source) and keep accurate records as to which photocopied bibliographic information pertains to which photocopied content.

Once the researcher has completed his or her research and is prepared to create a document describing his or her findings, the researcher must organize the content and attendant bibliographic information and then insert this information in the correct format within the document. In that this information is not in electronic form, this task involves manually reproducing the information in the document, for instance, by transcription using a keyboard. This manual transcription provides an opportunity for various mistakes to be made. For instance, where a quote from a particular source is to be used, it is possible for the researcher to incorrectly transcribe the quoted material. The researcher may also mis-transcribe the bibliographic information that pertains to the sources. Furthermore, where the user failed to record all such bibliographic information, the researcher may need to return to the source and rerecord this information.

In view of the foregoing, it can be appreciated that it would be desirable to have a system and method that, at least partially, automates the process of collecting content and source information that identifies the origin of the content. Furthermore, it would be desirable to have a system and method that, at least partially, automates integration of the content and source information into a document.

### SUMMARY OF THE INVENTION

The present disclosure provides a system and method for capture and utilization of content source information.

In one arrangement, the method comprises the steps of electronically capturing content, electronically capturing source information pertinent to the source of the captured content, associating the content and the source information; and transmitting the content and source information to a device for manipulation.

By way of example, this method can be practiced with a handheld scanning device. Such a device can comprise a housing configured as a pen, a scan head that is adapted to capture information from a source, and memory including an information association module that is configured to associate captured content with captured source information.

In one arrangement, the method comprises the steps of receiving content and associated source information pertinent to the source of the content in electronic form, reconfiguring the content and associated source information for use in a user application, and automatically creating at least one source acknowledgement in the user application.

Other methods, systems, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the invention.

FIG. 1 is a schematic view of the inventive concept.

FIG. 2 is a schematic view of a system for capture and utilization of content and source information.

FIG. 3 is a schematic view of a scanning device shown in FIG. 2.

FIG. 4 is a schematic view of memory of the scanning device shown in FIG. 3.

FIG. 5 is a schematic view of a computing device shown in FIG. 2.

FIGS. 6A and 6B provide a flow diagram that illustrates an example of operation of the scanning device shown in FIG. 3.

FIG. 7 provides a flow diagram that illustrates an example of operation of an information manager of the computing device shown in FIG. 5.

### DETAILED DESCRIPTION

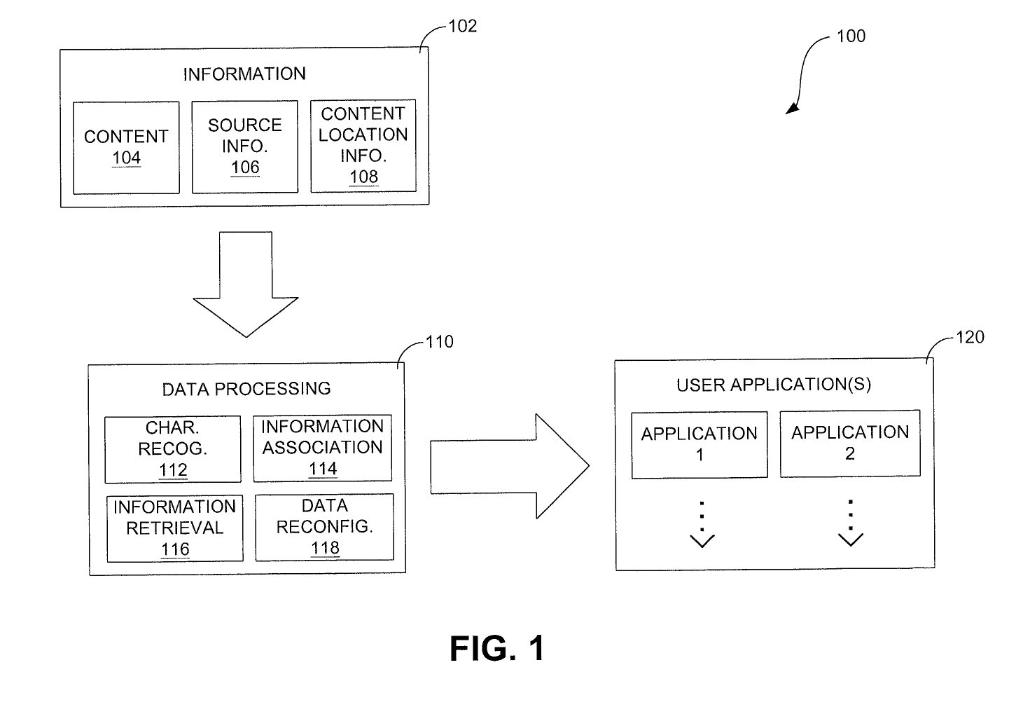

As noted above, there are several disadvantages associated with conventional research and document preparation in the research context. Accordingly, the present disclosure describes a system and method that, at least partially, automates the process of collecting content and source information as well as integrating the information with a user application such as a word processing application. The general concept 100 of the invention is illustrated in FIG. 1. As shown in this figure, while conducting his or her research, the researcher discovers various information 102 that the researcher may wish to use in creating a document that describes his or her findings. This information can include content 104, source information 106 associated with the discovered content, and content location information 108 that identifies where (e.g., on what page) the content was found. The content 104 can comprise any information that the researcher may wish to use in creating the document. For instance, the content 104 can comprise text that the researcher will use to write the document and/or that will be inserted into the document, for example as a quotation. The source information 106 typically comprises bibliographic information used to acknowledge the source in the research document. Accordingly, this information 106 typically comprises a title of the source (e.g., book or periodical), author, publisher, publication date, etc.

Once the content 104, source information 106, and content location information 108 is located by the researcher, it is recorded by the researcher so that he or she can later refer to this information and use it to prepare the research document. Due to the disadvantages associated with conventional methods of recordation of this type of information, the information 100 is electronically captured according to the present system and method. This is preferably accomplished by scanning the information 100. As for the content 104, various passages contained within the source can be scanned with an appropriate scanning device and stored within the scanning device. As for the source information 106, this information can be captured by scanning data code information, such as bar code information, provided on the source. For instance, where the source comprises a book, a bar code containing all bibliographic information can be provided on the binder of the book or title page. Alternatively, the bar code information can comprise look-up information with which the bibliographic information can later be retrieved for integration into the research document. Finally, the content location information 108 pertaining to each piece of located content 104 can be captured with the scanning device. For instance, the page numbers that identify the pages on which the located content 104 was found can be captured, if desired.

Once the various information 100 is captured as described above, various data processing can be performed on or with the information, as indicated in block 110. This processing can comprise character recognition 112, information association 114, information retrieval 116, and data reconfiguration 118. By way of example, character recognition 108 can comprise optical character recognition (OCR) of the captured content 104 and content location information 108 so that this information can later be directly imported in the research document, as desired. The information association 112 can comprise association of the content 104 with the source information 106 and content location information 108. The information retrieval 116 can comprise retrieval of bibliographic information where the data code information comprises look-up information. Finally, data reconfiguration 118 can comprise reconfiguration of the captured and retrieved information for integration with a user application 120.

Once the various data processing has been performed, the content 104, bibliographic information and content location information 108 can be integrated into one or more user applications 120. By way of example, the user application 120 can comprise a word processing application that the researcher uses to create the research document. In such a situation, the application 120 may exist and run on a separate computing device, for instance a personal computer (PC). Various options are available for this integration. For instance, the bibliographic information for one or more of the sources can be used to automatically create a bibliography for the document. In another example, content 104 can be imported directly into the body of the document in the form of a quotation and an acknowledgement automatically generated within the body of the document containing the relevant bibliographic information. Alternatively, such an acknowledgement for the imported content 104 can be automatically generated in the form of a footnote or endnote.

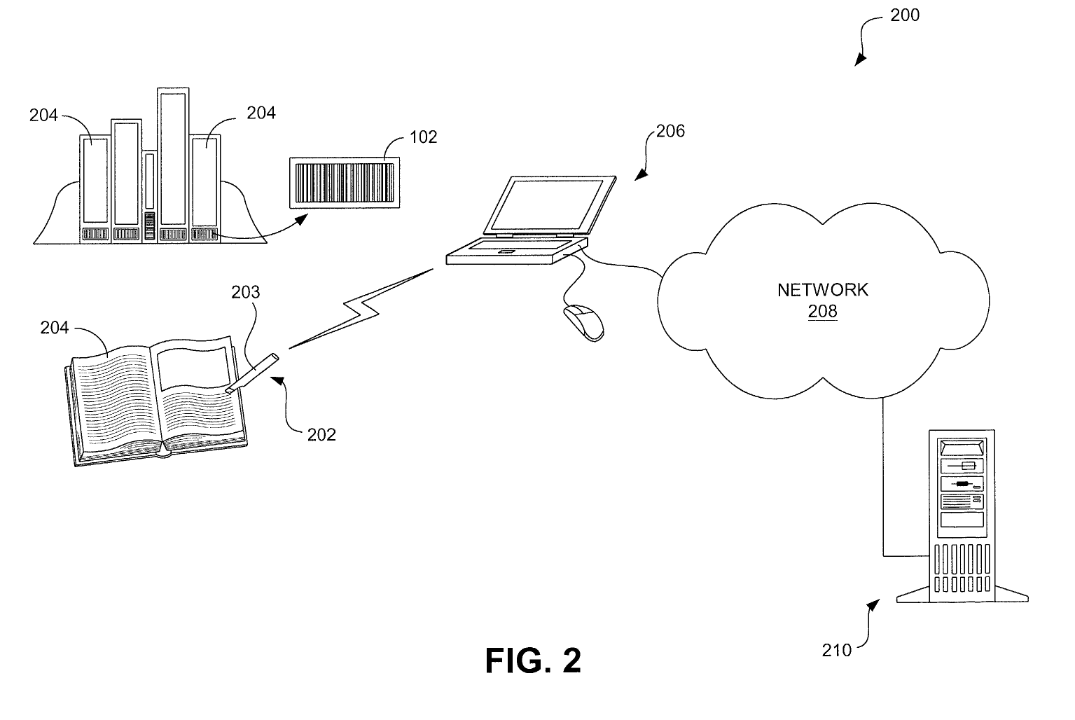

As can be appreciated from the above description, a system and method that operate according to the above-described conceptualization greatly simplify the research and writing process for the researcher and would prevent transcription mistakes that can be made by the researcher when conventional research and writing techniques are used. The general concept of the invention having been described, an example system for capture and utilization of content and source information will be described with reference to FIGS. 2-5. Although this system is provided by way of example, it will be appreciated that this system is described for purposes of illustration only and that various modifications are feasible without departing from the above-described inventive concept.

Referring now FIG. 2, illustrated is a system 200 for capture and utilization of content and source information. As indicated in this figure, the system 200 at least comprises a scanning device 202. The scanning device 202 typically comprises a self-contained, portable scanning device that, for instance, can be carried by the researcher (i.e., user) to a location (e.g., library) at which various sources 204 (e.g., books) can be found. By way of example, the scanning device 202 can include a housing 203 that is similar in configuration to a pen or highlighter with which the user can scan across text contained within a source 204 (typically a single line at a time), and scan across one or more data codes 206 (e.g., bar codes) of the source to capture source information that comprises bibliographic information or look-up information used to retrieve the bibliographic information. As noted above, such a data code 206 can be provided on a binder of the source 204 (FIG. 2) or on a title page of the source.

As is further indicated in FIG. 2, the system 200 can further include a computing device 206 with which the research document can be created and, as is described in greater detail below, the information captured by the scanning device 202 can be received. As indicated in FIG. 2, this information can be, for example, wirelessly transmitted from the scanning device 202 to the computing device 206. It will be appreciated, however, that this information can be transmitted through a direct electrical or optical connection, if desired. The computing device 206 can take many different forms. For instance, the computing device 206 can be configured as a desktop PC, laptop PC, or handheld computing device such as a tablet computing device, personal digital assistant (PDA), or mobile telephone. As will be appreciated by persons having ordinary skill in the art, the particular configuration of the computing device 206 is unimportant. The computing device 206 must merely be capable of receiving the information from the scanning device 202 such that it can be integrated into a research document or otherwise manipulated in some manner.

The computing device 206 can, optionally, be connected to a network 208 so that information contained within a remote computing device 210 can be accessed, if desired. The network 208 can comprise one or more sub-networks that are communicatively coupled to each other. By way of example, these networks can include one or more local area networks (LANs) and/or wide area networks (WANs). Typically, however, the network 208 comprises a set of networks that forms part of the Internet. As indicated in FIG. 2, the remote computing device 210 can comprise a network server. Although a network server is described and shown, it is to be appreciated that the server is provided as an example only and that this representation is not intended to limit the scope of the present disclosure.

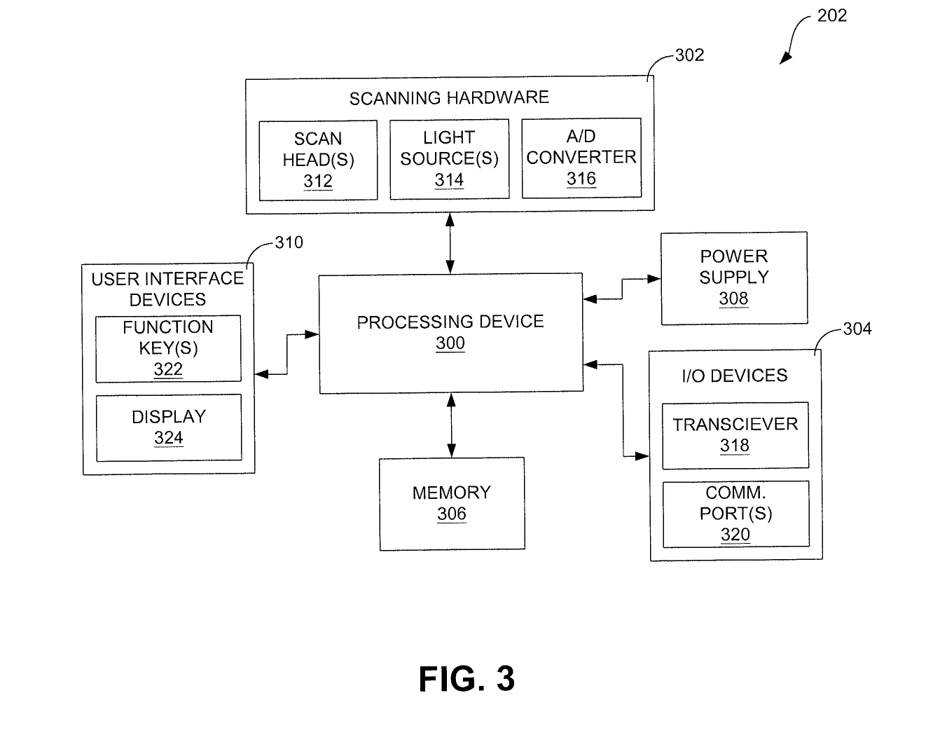

FIG. 3 is a schematic view illustrating an example configuration for the scanning device 202 shown in FIG. 2. Although a particular configuration for the scanning device 202 is shown in FIG. 3 and described herein, it will be appreciated that alternative configurations are feasible and may even be preferable. Indeed, the scanning device 202 can comprise substantially any existing or yet to be produced portable scanning device.

As indicated in FIG. 3, the scanning device 202 generally comprises a processing device 300 and scanning hardware 302, one or more input/output devices 304, memory 306, a power supply 308, and one or more user interface devices 310 that each are in electrical communication with the processing device. The processing device 300 is adapted to control operation of the other components of the scanning device 202 and execute commands stored in memory 306. The processing device 300 can comprise a general-purpose processor, a microprocessor, one or more application-specific integrated circuits (ASICs), a plurality of suitably configured digital logic gates, and other well known electrical configurations that comprise discrete elements both individually and in various combinations to coordinate the overall operation of the scanning device 202.

The scanning hardware 302 comprises the various components used to capture and store image information such as content, source information, and content location information. As indicated in FIG. 3, the scanning hardware 302 normally comprises one or more scan heads 312 and one or more light sources 314. As will be appreciated by persons having ordinary skill in the art, the scanning device 202 can comprise a single scan head 312 that is responsible for scanning (i.e., capturing) both text and data code information. In an alternative arrangement, the scanning device 202 can comprise two separate scan heads 312, one provided at each end of the scanning device. In such an arrangement, one of the scan heads is used to capture text (for content) and the other scan head is used to read data codes (for source information). In any case, the scan heads 312 can comprise a photosensor such as a charge coupled device (CCD).

Where provided, the light sources 314 (e.g., one provided for each scan head 312) can comprise a florescent, incandescent, or laser light source. Where the scanning device is used in environments in which enough ambient light exists, the light sources 314 may not be necessary. As is further identified in FIG. 3, the scanning hardware 302 typically further comprises an analog-digital (A/D) converter 316 that is used to convert the varying analog output of the scanning head(s) 312 into digital signals that can be manipulated by the scanning device 202 and/or the computing device 206 (FIG. 2).

In addition to the above-noted components, the scanning hardware may include other components that are not shown for purposes of simplicity. For instance, the scanning hardware 302 may further include a focusing mechanism comprising one or more lenses, mirrors, etc. Furthermore, the scanning hardware 302 may also include a position encoder that provides information as to position and velocity information about the scan head(s) 312, and a compensation circuit for reducing image distortion which may occur during scanning.

The input/output devices 304 can include a transceiver 318 and one or more communication ports 320 with which data can be transmitted to another device such as the computing device 206. The transceiver 318 can be configured for wireless communication that is facilitated through infrared (IR) transmission, radio frequency (RF) transmission, microwave transmission, or substantially any other wireless communication scheme. In addition or in exception, the communication ports 320 can be used to directly link the scanning device 202 with the other device through an electrical or optical connection such that data can be transmitted to the other device and, optionally, received from the other device.

The memory 306 can comprise a combination of volatile memory elements (e.g., random access memory (RAM, such as DRAM, SRAM, etc.)) and nonvolatile memory elements (e.g., ROM, hard drive, tape, CDROM, etc.) and is adapted to store various software (firmware) that comprises the various commands that, when executed by the processing device 300, control operation of the scanning device 202. The power supply 308 can comprise a portable power source that is integrated with the scanning device 202 such as a battery, or an external power supply that supplies the scanning device with direct current (DC) or alternating current (AC) power.

The one or more user interface devices 310 typically comprise interface tools with which scanning device settings can be changed and through which the user can communicate commands to the device 202. By way of example, the user interface devices 206 can comprise one or more function keys 322 with which the operation of the scanning device 202 can be controlled and, optionally, a display 324 that is adapted to communicate graphical information to the user (e.g., a liquid crystal display (LCD)).

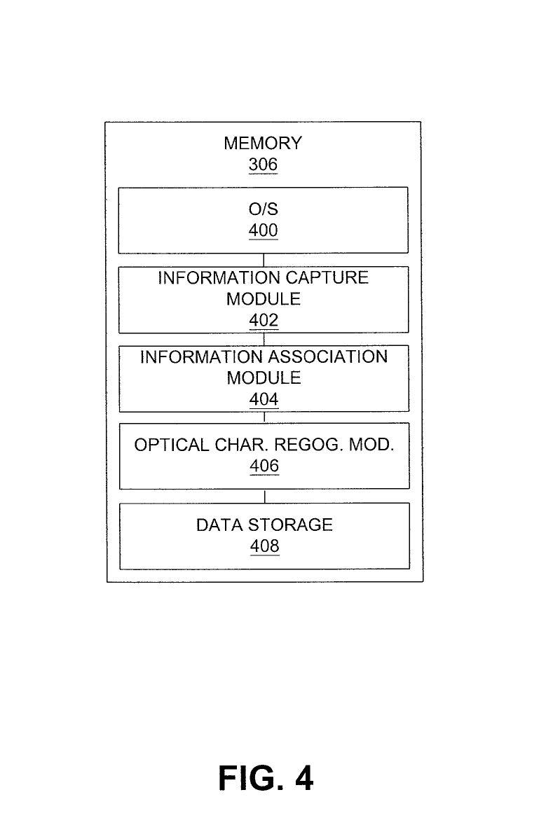

FIG. 4 schematically illustrates an example configuration of scanning device memory 306 identified in FIG. 3. To facilitate the description of the various software (firmware) disposed within memory 306, various software modules (e.g., programs) are depicted. Although separate modules are shown and described herein, persons having ordinary skill in the art will appreciate that these modules are provided as an example only in attempt to explain operation of the scanning device 202. Therefore, although specific modules are identified, one or more of these modules could be combined or divided as is deemed prudent. Furthermore, functions described herein as being performed by a particular module could be performed by other modules, as the software designer sees fit.

As indicated in FIG. 4, memory 306 can, for example, comprise an operating system 400 and an information capture module 402. The operating system 400 contains the various commands used to control the general operation of the scanning device 202 as well as the various software modules of memory 306. The information capture module 402 comprises software that is adapted to, in conjunction with the scanning hardware 302, capture information that can be, at least temporarily, stored by the scanning device 202 in data storage 408 and/or transmitted to another device (e.g., computing device 206) for further manipulation.

Further identified in FIG. 4 is an information association module 404 that, as is described in greater detail below, is adapted to associate various captured information (e.g., content) with other captured information (e.g., source information and content location information) so that the relationship between the various pieces of captured information can be tracked as data is manipulated in some manner (e.g., integrated into a user application). Finally, memory 306 can further comprise an optical character recognition (OCR) module 406 that is adapted to recognize raw text data and reconfigure the data into a format in which it can be imported into another application (e.g., word processing application) as text. Where the captured information is to be shared with another device, such as the computing device 206 provided with its own OCR module, the module 406 need not be provided to free up memory for other data and reduce the work for the processing device 300.

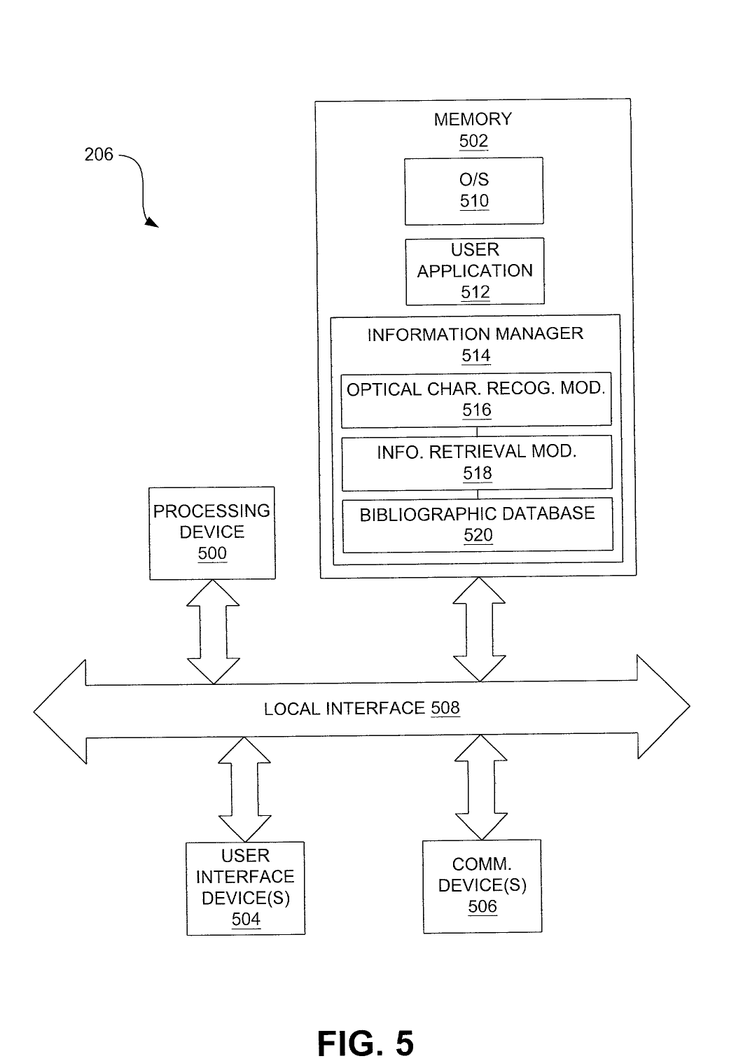

FIG. 5 is a schematic view illustrating an example architecture for the computing device 206 that can be used to receive captured information transmitted from the scanning device 202 and, if desired, can be used to integrate the information into a user application such as a word processing application. As indicated in FIG. 5, the computing device 206 can comprise a processing device 500, memory 502, one or more user interface devices 504, one or more communication devices 506, and a local interface 508 to which each of the other components electrically connects. The local interface 508 may have additional elements, which are omitted for simplicity, such as controllers, buffers (caches), drivers, repeaters, and receivers to enable communications. Furthermore, the local interface 508 may include address, control, and/or data connections to enable appropriate communications among the aforementioned components.

The processing device 500 can include any custom made or commercially available processor, a central processing unit (CPU) or an auxiliary processor among several processors associated with the computing device 206, a semiconductor based microprocessor (in the form of a microchip), or a macroprocessor. The memory 502, like memory 306, can include any one of a combination of volatile memory elements (e.g., random access memory (RAM, such as DRAM, SRAM, etc.)) and nonvolatile memory elements (e.g., ROM, hard drive, tape, CDROM, etc.).

The user interface devices 504 typically comprise those normally used in conjunction with a computing device. For instance, the user interface devices 504 can comprise a keyboard, mouse, monitor or display screen, etc. The one or more communication devices 506 comprise the hardware with which the computing device 206 can interface with the scanning device 202. By way of example, the communication devices 506 include a transceiver that is adapted to wirelessly transmit data to and wirelessly receive data from the scanning device 202. In addition, the communication devices 506 can include a device used to connect with the network 208, such as a modem.

The memory 502 comprises various software programs including an operating system 510, a user application 512, and an information manager 514. The operating system 510 controls the execution of other software and provides scheduling, input-output control, file and data management, memory management, and communication control and related services. The user application 512 can comprise substantially any application in which the information received from the scanning device 202 can be used. For example, the user application 512 can comprise a word processing application such as Microsoft Word™ or WordPerfect™. As is discussed in greater detail below, the information manager 514 is adapted to receive data transmitted from the scanning device 202 and integrate it into the user application 512.

The information manager 514 can include its own OCR module 516, information retrieval module 518, and a bibliographic database 520. Where provided, the OCR module 516 can receive raw captured data from the scanning device 202 and perform a character recognition on the data such that text represented by the data can be imported into the user application 512 as text. The information retrieval module 518 is adapted to retrieve bibliographic information with reference to source information transmitted by the scanning device 202. As described below, this bibliographic information can be retrieved from the remote computing device 210 via the network 208. Alternatively, this information can be retrieved directly from the local bibliographic database 520 if this information is contained in the database.

The remote computing device 210 (FIG. 2) can be configured in similar manner to the computing device 206. Accordingly, a detailed description of the remote computing device 210 is not provided here. However, it suffices to say that the remote computing device 210 typically comprises memory in which a further database is stored that contains bibliographic information which can be accessed by the computing device 206 when needed.

Various software and/or firmware programs have been described herein. It is to be understood that these programs can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system 200 having been described above, operation of the system will now be discussed. In the discussion that follows, flow diagrams are provided. It is to be understood that any process descriptions contained in blocks of these flow diagrams represent modules, segments, or portions of code which include one or more executable instructions for implementing specific logical functions or steps of the inventive method, and that alternative implementations are feasible. Moreover, functions may be executed out of order from that shown or discussed, including substantially concurrently or in reverse order, depending on the functionality involved.

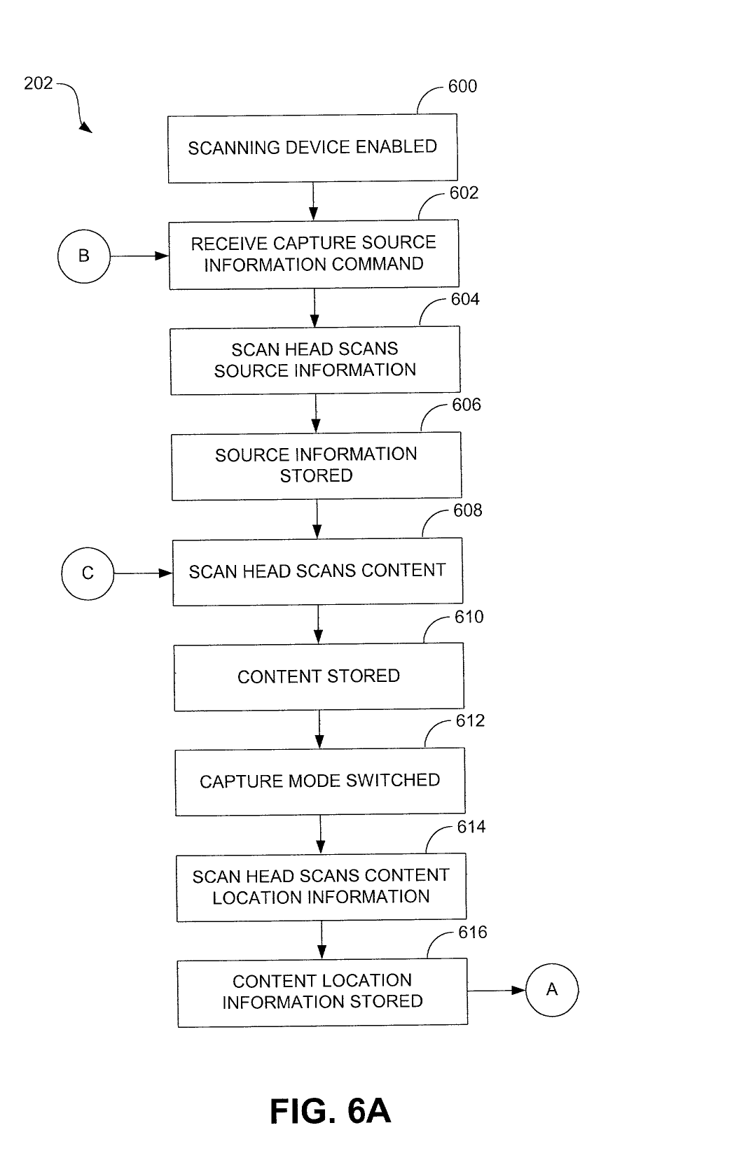

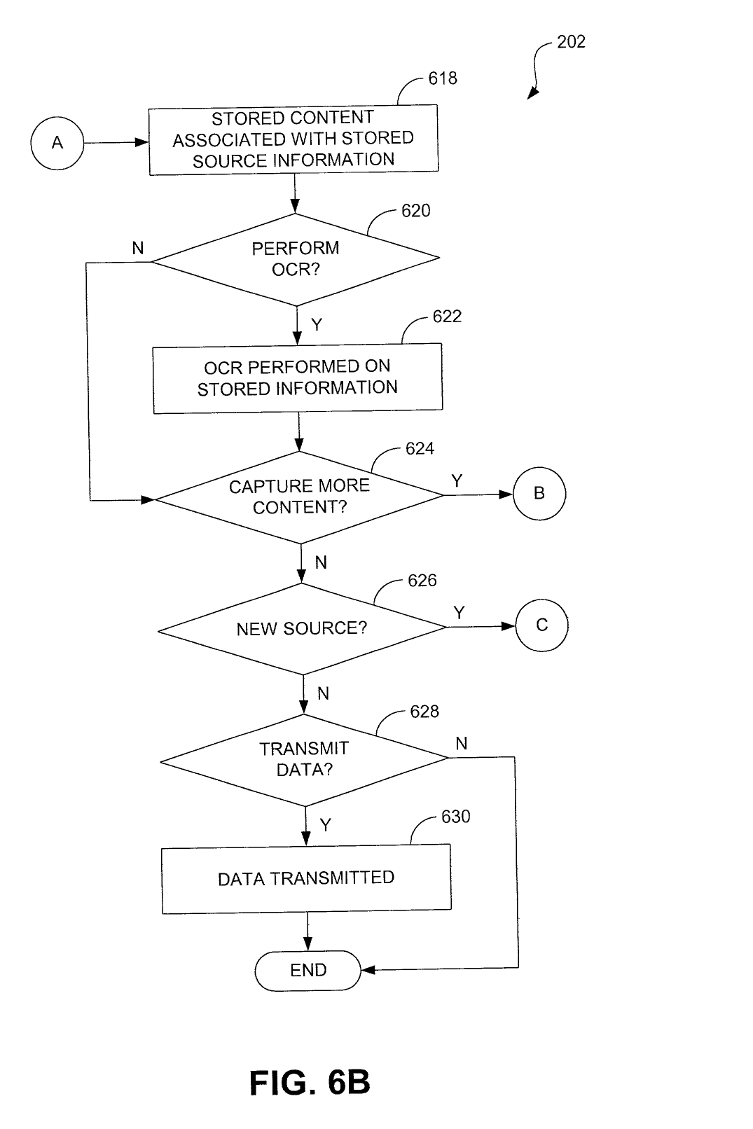

FIGS. 6A and 6B illustrate an example of operation of the scanning device 202 in capturing information located during research that can be used in some manner, for instance in creating a document. Beginning with block 600 of FIG. 6A, the scanning device 202 is enabled. This enablement can comprise the powering of the device through selection of a power button provided on the device 202 or other function key. Once the scanning device 202 is enabled, it can receive a capture source information command, as indicated in block 602, entered with one or more of the function keys of the user interface devices 310. Receipt of such a command indicates to the scanning device 202 that source information will be captured with the scan head 312 of the device. The source information typically is obtained from data code information that is provided on or in the source (e.g., book). The source information may comprise bibliographic information for the source such as a title, author, publisher, and publication date. Alternatively, the source information can comprise information that identifies where such bibliographic information can be found such that it may later be retrieved.

The scan head 312 scans the source information, as indicated in block 604, and, as indicated in block 606, the source information is stored in memory 306. As indicated above, the scanning device 202 can comprise a single scan head or separate text data code scan heads. Where two separate scan heads are provided, the scanning is conducted with the data code scan head. At this point, the scanning device 202 is then prepared to capture content contained within the source. Therefore, the scan head 312 then scans the content, as indicated in block 608. Where two scan heads 312 are provided, this content capture can be accomplished with the text scan head. As with the captured source information, the captured content is stored in memory 306, as identified in block 610. Once the desired amount (e.g., a particular passage) of content has been captured and stored in this manner, content location information, for instance one or more page numbers on which the content was found, can further be captured and stored, if desired. To accomplish this, the scanning device 202 can switch capture modes, as indicated in block 612, for example in response to a location information capture command received from the user. This way, the scanning device 202 will know that this information is to be used in creating the acknowledgment of the source when a document is later created.

At this point, the scan head scans the content location information, as indicated in block 614, and the information is stored, as identified in block 616. Where the captured content begins on one page and continues onto another, the content location information can comprise a first page number and a second page number. In such a situation, the capture process may comprise first capturing the first page number, receiving an indication that the first page number has been captured, and then capturing the second page number. Alternatively, the scanning device 202 can be configured to automatically recognize when two separate page numbers have been captured. Although the content location information is described as being provided as text, it is to be appreciated that other indicia, such as further data code information, can be used to identify the location of the content, if desired. Furthermore, although the content location information is described as being captured after the content is captured, it will be appreciated by persons having ordinary skill in the art that these steps could be reversed, if desired.

Once the source information, content, and content location information have been captured in the manner described above, flow continues to block 618 in FIG. 6B at which this information is linked such that the captured content is associated with a particular source as well as a particular content location (where applicable). This may comprise, for instance, the use of metadata tags applied to the various pieces of information. At this point, it can be determined whether OCR is to be performed on content and content location information, as identified in decision element 620. As identified above, performance of OCR with the scanning device 202 may not be necessary where the computing device 206 has this capability. Where OCR is not to be performed, flow can continue down to decision element 624 described below. If OCR is to be performed, however, flow continues to block 622 at which the OCR module 406 processes the captured content and content location information to identify characters.

Referring now to decision element 624, it can be determined whether more content, and its attendant content location information, is to be captured from the source. If so, flow returns to block 608 at which the scan head 312 scans the content as described above. If no further content is to be captured from the source, however, flow continues to decision element 626 at which it is determined whether content is to be captured from a different source. If not, flow continues to decision element 628 described below. If content from another source is to be captured, however, flow continues back to block 602 at which a capture source information command is again received.

With reference now to decision element 628, it can be determined whether the captured information is to be transmitted to another device such as the computing device 206. By way of example, the transmission can occur immediately after the research is completed, for instance, where the user has brought a portable computing device (e.g., laptop PC) to the research location, or later where the user intends to transmit the information to a stationary computing device (e.g., desktop PC). If the information is to be transmitted, flow continues to block 630 at which the information is transmitted via the input/output devices 304. If, on the other hand, the information is not to be transmitted at this time, the session is over and flow is terminated.

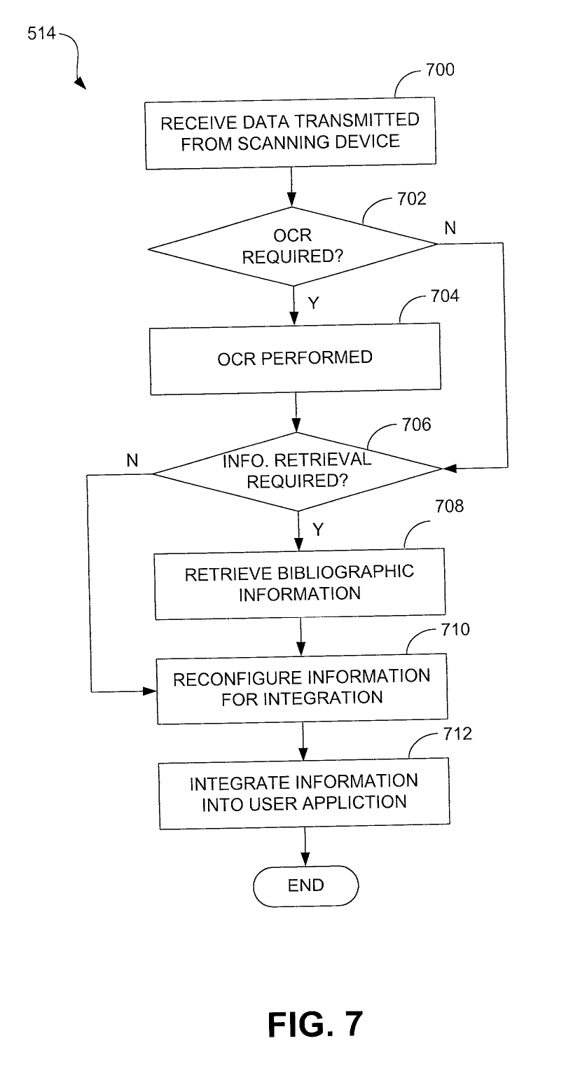

Reference is now made to FIG. 7, which illustrates an example of operation of the information manager 514 of the computing device 206 shown in FIG. 5. As indicated in block 700, the data transmitted from the scanning device 202 is received. At this point, it can be determined whether OCR must be performed on the content and content location information that was captured in the research session, as indicated in decision element 702. This determination can be made through analysis of the received data to determine whether OCR has already been performed and/or whether the content and content location information comprises raw data. If OCR is not required, flow continues to decision element 706 described below. If OCR is required, however, it is performed on the raw data, as indicated in block 704.

With reference to decision element 706, it is determined whether the bibliographic information must be retrieved. Such retrieval is necessary where the source information only comprised an identification of where bibliographic information is stored versus the bibliographic information itself. The identification can comprise, for instance, information used to look-up the bibliographic information in the bibliographic database 520 or an address (e.g., universal resource locator (URL)) that identifies where the bibliographic information is stored out on the network 208. If the source information comprises the bibliographic information, flow continues down to block 710 described below. If this information must be retrieved, however, flow continues to block 708 at which the bibliographic information is retrieved from the local database 520 or from a database of a remote device such as the remote computing device 210.

With reference to block 710, the captured information (and retrieved bibliographic information where applicable) can then be reconfigured for integration into a user application such as a word processing application. This reconfiguration can take many different forms depending upon the user's wishes. For instance, the user can be provided with the choice of having the information manager 514 automatically create a bibliography for a document he or she is creating with the captured (and retrieved) information. In another example, the user can have the information manager 514 automatically generate footnotes or endnotes as specific pieces of content are imported into the document by the user. By way of example, these choices can be communicated by the user with a separate application itself associated with the information manager 514 or can be communicated with the user application itself where the application is configured to receive such choices.

At this point, the content can be integrated into the user application, as indicated in block 712. This integration can result from, for instance, selection by the user of one or more content portions for importation into the document. In such a scenario, the information manager 514 can, at the choice of the user, automatically generate an appropriate acknowledgement of the source in the form of a notation in the bibliography, footnote, and/or endnote. Such importation can continue in this manner until all captured content that the user wishes to use has been added to the document. At this point, flow for the information manager 514 is terminated.

From the above, it can be appreciated that research and document creation can be greatly simplified with a system for content and source information capture and integration such as that described above. While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for collecting information when conducting research, comprising the steps of:
electronically capturing content;
electronically capturing source information pertinent to the source of the captured content;
associating the content and the source information; and
transmitting the content and source information to a device for manipulation.

2. The method of claim 1, wherein the step of electronically capturing the content and source information comprises capturing the content and source information with a common scan head of a scanning device.

3. The method of claim 1, wherein the step of electronically capturing the content and source information comprises capturing the content and source information with separate text and data code scan heads, respectively, of a scanning device.

4. The method of claim 1, wherein the step of electronically capturing source information comprises scanning a bar code of the source.

5. The method of claim 1, wherein the source information comprises bibliographic information pertinent to the source.

6. The method of claim 1, wherein the source information comprises information that can be used to retrieve bibliographic information pertinent to the source.

7. The method of claim 1, further comprising the step of capturing content location information that identifies where the content was found in the source.

8. The method of claim 7, wherein the content location information comprises one or more page numbers.

9. The method of claim 1, further comprising the step of performing optical character recognition on the content.

10. A device for recording information when conducting research, comprising:
means for electronically capturing content;
means for electronically capturing source information pertinent to the source of the captured content;
means for associating the content and the source information; and
means for transmitting the content and source information to a device for manipulation.

11. A method for using captured information, comprising the steps of:
receiving content and associated source information pertinent to the source of the content in electronic form;
reconfiguring the content and associated source information for use in a user application; and
automatically creating at least one source acknowledgement in the user application.

12. The method of claim 11, wherein the step of receiving the content and associated source information comprises receiving the content and associated source information with a handheld scanning device.

13. The method of claim 11, wherein the at least one source acknowledgement includes a bibliography.

14. The method of claim 11, wherein the at least one source acknowledgement includes a footnote.

15. The method of claim 11, wherein the at least one source acknowledgement includes an endnote.

16. The method of claim 11, further comprising the step of receiving content location information pertinent to the location of the content within the source.

17. The method of claim 11, further comprising the step of retrieving bibliographic information pertinent to the source using the source information.

18. The method of claim 11, further comprising conducting optical character recognition on the content.

19. A system for using captured information, comprising:
means for receiving content and associated source information pertinent to the source of the content in electronic form;
means for reconfiguring the content and associated source information for use in a user application; and
means for automatically creating at least one source acknowledgement in the user application.

20. A handheld scanning device, comprising:
a housing configured as a pen;
a scan head that is adapted to capture information from a source; and
memory including an information association module that is configured to associate captured content with captured source information.

21. The device of claim 20, wherein the device comprises two separate scan heads, one provided at each end of the device, one of the scan heads being adapted to capture text and the other scan head being adapted to capture data code information.

22. The device of claim 20, further comprising a transceiver that is adapted to transmit captured information to another device for manipulation.

23. The device of claim 20, further comprising an optical character recognition module stored in memory.

24. The device of claim 20, wherein the scan head comprises a charge-coupled device (CCD).
